(19) United States
(12) Patent Application Publication
(10) Pub. No.: US 2009/0202777 A1
(43) Pub. Date: Aug. 13, 2009

(54) Heat and Fire Protection Covering

(76) Inventors: Gabriele Stein, Elchingen (DE); Yehia Yousif, Neu-Ulm (DE)

Correspondence Address: JACOBSON HOLMAN PLLC, 400 SEVENTH STREET N.W., SUITE 600, WASHINGTON, DC, 20004, US

(21) Appl. No.: 11/658,888

(22) PCT Filed: Jul. 29, 2005
(86) PCT No.: PCT/EP2005/008251

§ 371 Date: Jan. 30, 2007

(30) Foreign Application Priority Data
Jul. 31, 2004 (EP) 04018211.5

(51) Int. Cl. B32B 5/16; A62C 8/06

(52) U.S. Cl. 428/86

(57) ABSTRACT

The invention relates to a heatproof and fireproof cover, in which a nonwoven that contains a superabsorbent material is located between an outer skin and a covering skin.

The invention refers to a covering for the heat and fire protection of objects (for example buildings, pieces of equipment, machines, EDP systems, humans, floors) which are located near seats of fire/fires.

### STATE OF THE ART

Heat and fire protection coverings are used, as a rule, for protecting objects which are in the direct vicinity of the fire and thus are at risk of being damaged. Usually, the damage is not done by the fire itself but mainly by the heat as well as the developing smoke and the corresponding high temperatures in the air as well as poisonous and non-poisonous gases which develop here. In addition to that huge damage occurs by water used for fire fighting (“water damage”).

Known coverings or protection measurements of incombustible or hardly inflammable materials have the disadvantage that they cannot be used practically in large sizes (for example for buildings, they are either too heavy or not fast to handle). Additionally the covering cannot release cooling in order to lower the heat developing in the fire or to prevent the water damages occurring during the fighting of the fire. They may also be applied in liquid form (SAP gel) to the object to be protected and can hardly be removed again or they often render the objects to be protected useless. Additionally, most of the coverings or protection means used so far are either very expensive and/or they cannot be used a second time.

In reality the covered objects, despite the coverings used until now, are damaged so badly that they cannot be used, repaired or maintained anymore, and another considerable, economic damage is the result. As a rule these coverings thus often are not used at all as additional costs and expenses result, however, there is no real protection.

It is an object of the invention on which this specification is based to provide a heat and fire protection covering which compensates the disadvantages of the previous coverings and offers actual advantages for the use with heat, fire and blazes.

### DESCRIPTION OF THE INVENTION

This problem described before is solved by a heat and fire protection covering, where a fleece with a super absorber is arranged between an outside skin and a cover skin. Outside skin and cover skin form, as it will be described later on, a sheathing or an enveloping cover fabric. According to the invention it is possible that the outside skin and the cover skin are either identical or even different. The arrangement is chosen in such a way that the cover skin faces the object to be protected, and the outside skin faces the fire or heat source.

An exemplary embodiment of the heat and fire protection covering according to the invention is described briefly in the following, however, without the intention of reducing the invention to this concrete embodiment. The heat and fire protection covering according to the invention comprises two parts:
a. First of all a light and flexible filling material. This consists of a synthetic fleece made from polyester (carrier fleece) coated with a so-called super absorber (super absorbing polymers=SAP). Super absorbers are known from the state of the art. They are a web of flexible, hydrophilic polymerides which may have ionic as well as non-ionic properties. They are able to absorb and bind watery liquids and are therefore used, for example, for absorbing body liquids in sanitary articles like diapers or the like. In addition to that super absorbers are also used in fields of technique where liquids have to be absorbed. Also in the field “fire protection” super absorbers are already used. This is carried out in the form of a SAP gel which is sprayed on houses, or is used to prevent forest fires from spreading. The disadvantage of the gel is its liquid condition. After the fire it has to be removed, which is a problem, in particular in nature. However, also houses and other objects like cars, EDP systems etc. have to be cleaned from the gel. As the gel, of course, enters even gaps and openings of an object, it is partly not possible at all to remove the gel completely, and the object is often either damaged or does not work or does not work fault free. A renovation or repair causes, if even possible at all, additional expenses. Besides, the gel cannot be used again and has to be disposed of.
b. Secondly the invention comprises a cover fabric enveloping the fleece, which comes already in many colours and variations by different producers, the top and bottom side of the sheathing (that is the outside skin and the cover skin) being different (cover fabric 1 and 2). These are, for example, CS fabric, Goretex, aluminium, or other fireproof or hardly inflammable materials. The cover fabric, ready made from one or two materials, serves as sheathing for the synthetic fleece. The sheathing is pulled over the synthetic fleece, and made in the suitable size as cover. Additionally, the material is stitched closely readily enveloped or depending on the cover fabric fixed in another way so that for cutting the respectively required amount the synthetic fleece is held in the sheathing. The material can be put on rolls in piece goods, or serve as individual blankets or mats in different sizes or put in or on or attached to clothing for heat protection. In addition to that the invention can also be combined with other materials or be attached to other objects, (for example poles, scaffolds). Of course, also ready-made sheathings may be produced for objects, for example cars, EDP systems, etc. which then can be pulled quickly over the objects and offer instant protection. In order to prevent the object from becoming wet under any circumstances the bottom side of the covering (the cover skin 1), that means the side facing the object to be protected is impermeable to water, if necessary. The top side of the sheathing (the outside skin 2) opposite the object is permeable to water, air and water steam in order to secure absorption and evaporation of the bound water, and thus to produce the cooling effect.

### ADVANTAGES OF THE INVENTION

In a preferred embodiment of the invention it is provided that the covering, in particular the super absorber, absorbs and binds preferably water. The absorption of water has two essential effects. On the one hand, there is a liquid reservoir which can evaporate for cooling purposes, on the other hand, the physical properties of the covering are different when it is loaded with water. It becomes heavier and also forms a mechanic protection of the object to be protected. Surprisingly, thus the heat and fire protection covering according to the invention cannot only be used for cooling, but there is also the chance to offer a certain mechanic protection for the object to be protected.

An essential advantage of the invention is the fact that the liquid bound by the super absorber escapes by evaporating from the fleece or the covering, and the evaporation heat is taken from the surroundings of the covering, in particular from the object which is covered with the covering, and thus this object is cooled. Thus the object to be protected conveys heat, and the risk that this object is damaged, for example, by effects of extreme heat is reduced considerably.

In the following a number of advantages of the invention is listed. These advantages are the result in particular of the combination of several characteristics each claimed individually in the claims.

### Heat and Fire Protection by Cooling to the Outside by Physical Evaporation of the Absorbed Water

The invention offers optimal heat and fire protection as, on the one hand, the materials themselves are hardly inflammable or incombustible through their properties and thus are not involved or participate in the fire process itself, but protect. Secondly, the advantages of the invention are the ability of the invention, and, in particular, of the comprised fleece, to absorb water, and to convey it only through evaporation (not by mechanic effects as, for example, wringing or squeezing), and thus to contribute to cooling when the temperature is high. By means of that the objects to be protected from fire are kept cool and are not damaged by fire, heat or hot smoke or gases. Even combustion of the objects to be protected is prevented by that, as well as possible explosions which may occur through the heat and would thus further accelerate the fire. Additionally, also the oxygen required for burning is kept away as far as possible. Furthermore, the fleece gets a very high mechanic stability by the activation with water, and thus is able to protect the objects to be protected excellently from mechanic attacks from the outside as well as from the fire itself. The water, which is used accordingly with large fires and high risks, is put on already for activating the material in a defined amount after enveloping the objects, may be removed preferably not by mechanic pressure but it escapes only by evaporating, which causes physically the effect of the evaporation cooling. Through the water bound in this way in the material of the invention, thus, when heat develops from the outside (blaze, fire, etc.), a strong cooling effect is the result which depends on the temperature. The higher the temperature of the surroundings the stronger the cooling effect. This cooling effect results solely from the physical effect of the evaporation of the water bound by the material at high temperatures. Therefore the cooling effect protects the covered objects in an optimal way from the heat or hot smoke developing in fires.

Very Light Material and thus Simple and Easy Transport or Storing

By means of this invention a material is used in the field of fire protection coverings which is very light and can be transported, for example, in rolls. Thus very large surface coverings, as for example for buildings, can be obtained handily. As the material is very lightweight it is, of course, very simple to transport. As it is in addition very flexible and is adapted often only at the place of application to the size and shape of the objects to be protected from blaze and fire, it can be stored at any dry place.

### Very Flexible Material

The material used in the invention is very flexible which allows a use as covering also for uneven objects without parts being damaged by the enveloping. Additionally each object may be enveloped in such a way that actually all components of the objects are reached by the sheathing so that no openings are left which could offer an entrance way for the heat. The sheathing can be made practically impenetrably.

Easy to Work with Scissors or Other Cutting Tools

The material used for the invention can be formed and be brought fast and easily into each desired shape by suitable cutting tools (scissors, knives, etc.), and can be worked, for example sewed, easily. This offers real advantages when any possible object should be sheathed, because by means of that the material can be stored in the form of large surfaces or in rolls, and has to be brought to the suitable shape only when used. A pre-determined size is not necessary here and makes the application very flexible. The invention is thus independent from size and shape of the object to be protected. By the variable stitching or fixing the fleece is held firmly in the sheathing and cannot slip. During cutting thus the firm connection between cover fabric and fleece material is guaranteed. Furthermore. Also ready-made heat and fire protection sheathings can be produced fast and economically in determined sizes in different shapes for a quick pulling-over over objects.

### Water Absorption Up to 10 to 20 Times of its Weight Without Releasing it by Means of Mechanic Pressure

The fleece in the invention can absorb water because of its structure and its specific coating depending on the thickness and amount of coating in the amount of 10 times up to 20 times of its weight. This offers clear advantages for the use in fires. Besides the property as covering and thus occurring safe protection from direct contact of the objects to be protected from materials acting from the outside or heat and smoke during a fire or in the fighting of a fire in addition to that the water for fire fighting is bound and cannot get to the object to be protected. The material of the invention does not release the bound water by mechanic pressure but by evaporation so that the sheathed object does not get wet. Additionally, the side of the sheathing facing the object is made with watertight material. By means of that the object is protected from water damages which often occur during fires.

### Fireproof and Hardly Inflammable

The fleece of the invention is hardly inflammable and has in dry condition properties similar to polyester with an ignition temperature of 500° C. as well as a melting point of 250° C. The cover fabric is tested and in particular suited for that and thus also hardly inflammable and fireproof, respectively.

Thus the material can already in dry condition be called fireproof to a large extent which is important for the field of application.

Through the use of the material in the condition activated by water (moist) the ignition temperature and the melting point cannot be determined anymore. Thus the invention can be called fireproof.

Therefore the fire can get directly to the surface of the fire protection covering without damaging the material. The object to be protected is cooled optimally by the high temperature from the outside and the evaporation of the bound water developing because of that, and is thus not damaged. Another application of water during the fighting of fire maintains the effect also beyond the single evaporation time.

### Reusable

As the material absorbs water, thus cools and protects from heat, and releases the water only through evaporation the product can be reused unlimited times and applied reversibly. After the use in a fire the water evaporates, and the product can thus be stored in dry condition in order to be used again in the next fire. The reuse makes the product environment friendly and additionally more economically than, for example, throwaway tarpaulins or gels.

### Safe for Men and Nature

The material of the invention is safe for men and nature, and does not release, if it catches fire in the dry condition, poisonous or harmful materials. In the unlikely case that the material burns only different amounts carbon monoxides develop depending on the oxygen content. Thus the material is also safe in this respect as these materials also occur when, for example, wood is burned.

### Other Properties of the Invention:

Of course, different fleece materials with different thickness and ability to bind water can be produced, and, depending on the requirements, be used for measurements for fighting fires. Through the larger thickness of the material or larger amount of the super absorber coating of the fleece the degree of the ability to bind water increases. Of course, in the same way the weight of the fleece per m² increases, however, this occurs only in a small scale and thus has hardly effects on the handling. However, with a larger amount of coating the mechanic stability of the material in moist condition increases so that a mechanic working stress is the result which may be actually an advantage in the frame of fire fighting. A strongly coated material in moist condition has a similar stability as flexible synthetic material (“rubber”), and resists strong mechanical stress (for example hail, dropping or flying objects, for example, in an explosion, etc.). Through the rubber-like consistency hits and mechanic effects from the outside are absorbed (shock absorber property).

According to the invention it is provided that a fleece with a super absorber is arranged between an outside skin and a cover skin. A number of different modifications are possible for the design of the fleece with the super absorber. All these modifications include a fleece with super absorber according to the invention.

For the time being it is thus suggested according to the invention that the fleece is coated with super absorber. Usually the fleece consists of fibre material, the fleece itself is, for example, a woven or non-woven, surface material with textile or flexible properties. The fibre material forming the fleece is here, for example, coated with super absorber, the super absorber, for example, being fixed by a binding agent on the fibre forming the fleece. Such a modification is described, for example, in the European Patent Application 676 496 to which is referred here completely.

Another modification of the invention provides that the super absorber is fixed on the fibre forming the fleece by the effect of heat and/or pressure. Instead of a separate additional binding agent here the adhesion powers of the super absorber and the fibre material of the fleece are decisive in order to produce an adhering link between the two materials. It has been found here that with a corresponding pressure temperature combination the use of a binding agent is obsolete. Such a design has been described, for example, in the International Patent Application WO 2004/039493 which is referred to here completely.

The two modifications mentioned before eventually form a relatively homogenous fleece material where preferably the amount of super absorber in the fleece is distributed equally.

In another modification of the invention it is provided that the super absorber is arranged as a largely homogenous layer next to one or between two fleeces. In such a modification the fleece is more supposed to stabilise and align the position of the super absorber. The super absorber itself thus forms a largely homogenous layer next to another again itself homogenous layer. Such an arrangement is also part of the invention, here also the fleece comprises a super absorber.

In another modification according to the invention it is provided that the fleece is coated on one or both sides with super absorber. Such a modification is also shown in the figure. Thus, for example, a usual polyester fleece or another non-woven fleece is coated with a sodium polyacrylate super absorber with a concentration of 200 or 400 grams per square meter on both sides. Such an arrangement has the effect that the super absorber is provided in the fleece not homogeneously but distributed in layers. Then it is, for example, at the outsides of the fleece.

It has been found that a concentration of super absorber of about 100 to 500 grams per square meter, preferably 200 or 400 grams per square meter, produces very good results.

It is here possible, according to the invention, that the super absorber is arranged as gel, paste or flakes in the fleece. The consistency of the super absorber can be adjusted accordingly and also be optimised. For example, a flake-like design is used in order to attach the super absorber to the fibre parts.

In a preferred modification of the invention it is suggested that in particular the outside skin facing the heat or fire source is incombustible and/or hardly inflammable and/or permeable to water and/or permeable to water steam. Conveniently the outside skin is made, for example, of suitable textile or other flexible material. In order to produce the desired qualities it is, for example, possible to coat or to finish the outside skin. As the covering according to the invention is used in particular for the protection in the case of fire it is, of course, a large advantage if the outside skin is correspondingly fireproof. Also, if the outside skin is suitably hardly inflammable, the purpose is reached.

The water permeability of the outside skin makes it easier to activate the heat and fire protection covering. The cooling effect cannot occur before liquid, in particular water, is bound in the super absorber. In order to get the water as fast as possible into the covering it is convenient that the surface, here the outside skin, is designed permeably to water in order to make thus a wetting or loading of the fleece containing the super absorber possible.

Eventually the cooling effect through withdrawing the evaporation heat from the environment is used. The water steam occurring here should escape, so that it is convenient that the material of the outside skin is permeable to water steam.

It is furthermore suggested according to the invention that the cover skin in particular facing the object to be protected is waterproof and/or impermeable to water and/or well heat conducting and/or gas-tight or oxygen-tight. In a similar way as the outside skin can be optimised and has according properties which can be combined with each other, also the cover skin is optimised for the particular case of application. The cover skin faces the object to be protected, the object should be cooled, if possible, and is not supposed to be damaged by the water for fire fighting.

Therefore it is convenient if the cover skin is waterproof, that means is not dissolved by water and, on the other hand, does not let water pass through.

In order to cool the object to be protected preferably, exactly the large surface contact region between object and cover shin is designed well heat conducting, in order to withdraw evaporation heat from just the object to be protected. This may be reached by accordingly well heat conducting materials, for example metal foils, metal inlays or synthetic materials with suitably good heat conducting properties. Such materials are also used foil-like and flexible, respectively, and can thus be used, as it is suggested according to the invention, in large lengths.

It has been described that, of course, a protection for the object may also be reached if in the region of the object there is a low oxygen concentration or a poor supply of oxygen in order to prevent the start of a fire as far as possible. It is thus an aim to cover the surface of the object with the fire protection covering, if possible entirely, so that then the cover skin is gas-tight or oxygen tight, and no oxygen can be supplied in the region of the object. However, if an oxygen supply is excluded the risk of a fire of the object to be protected is reduced further.

Cleverly it should be achieved that the cover skin and the outside skin, respectively, consist of textile or flexible material so that handling, transport and the application of the invention is improved considerably.

In an example a fleece equipped with super absorber has a fibre/super absorber ratio of 2.5:1. With such a starting material the result then is a water absorbing capacity of 1500% in the relation to the weight. The invention makes a wide field of application possible by means of the design of the fleece. Thus it is, for example, provided that the weight ratio of fleece to super absorber is 15:1 to 1:15, preferably from 15:1 to 1:1, and in particular preferred from 7:1 to 2:1. In another case of application of the invention more super absorber than fleece is provided with respect to the weight. Thus a fleece with a gsm substance of 70 g/m² is equipped with a super absorber with a gsm substance of 200 to 400 g/m² so that preferably an interval for the weight ratio of fleece to super absorber from 1:2 to 1:7 is the result for the invention.

Also the size of the used super absorber particles is very variable. It is provided that they may have a diameter ranging from 10 μm to 2000 μm. The application of the super absorber in the fleece depends on the size of the super absorber particles, for example the way the absorber is linked with the fibres of the fleece. It is, of course, also possible that relatively large super absorber particles serve as filling material for a sheathing comprising outer skin and cover skin, and in this respect the super absorber itself is, if possible, also the fleece material as bulk or flow material. The fleece then has, for example, filter or retaining function. Also such a modification of the invention is provided.

Conveniently the super absorber particles consist of poly(meth)acrylic acid or poly(meth)acrylic acid copolymerides with a content of at least 50 weight % methacrylic acid. However, also other super absorber materials can be used.

The fleece can be produced from very different materials. It may consist of viscose, cellulose, polyurethane, polyester, poly(tetrafluorethylene), silicon, aramide, polyamide, cotton or suitable mixed fabrics of the materials mentioned before.

Preferably a fleece with a gsm substance of 50 to 200 g/m² is used, very good results are obtained with a fleece of 70 g/m².

It is convenient that the outside skin and the cover skin are linked to each other by closing seams. In particular, if the heat and fire protection covering according to the invention is used in lengths or rolls, a suitable stitching is convenient in order to avoid securely and reliably a gaping of outside skin and cover skin and the escaping of the fleece. The closing seams are provided here conveniently regularly and spaced not too far. The result here is the advantage that a covering can be produced customised on short notice.

It is furthermore convenient that the covering comes in lengths or rolls and has, for example, connecting means on the side. Thus it is, for example, possible to supply lengths or rolls of 2 m or 3 m length in order to realise, for example, in the case of heat or fire a covering of 10 m×10 m. The lengths and rolls, respectively, are accordingly cut to length and linked to each other by means of their laterally arranged connecting means which interact with each other. This may be, for example, Velcro connecting means or even buttons, zippers or the like. A connection means which is in particular gas-tight or oxygen-tight has to be preferred for the protection of the object to be protected.

It is, of course, also possible to form the covering according to the shape of the objects which have to be covered.

Thus it is, for example, possible, in a modification of the invention, to design the covering as an article of clothing, for example as jacket, suit, pants or the like. Thus the invention serves in particular for protecting people. Through the cooling effect the period of operation of, for example, firemen, is increased considerably in corresponding fires, the risk of accidents by tiring as a result of overheating is reduced.

The additional mechanical stability and ability to absorb shocks resulting from the water absorption has already been pointed out several times.

The invention comprises furthermore a method for the protection of objects in the case of fire. By the procedure according to the invention and described in the following an effective and reliable protection for objects to be protected is obtained. By means of the method according to the invention a heat and fire protection covering, preferably as described, is arranged between the object to be protected and the fire or heat source, after that the covering is watered, and then the evaporation of the liquid cools and thus protects the object. Cleverly the object to be protected is covered.

The use according to the invention of the invention is described in the following by means of different embodiments:

Heat and fire protection blanket in different sizes

Heat and fire protection covering in rolls for the large-scale use and individual adjustment to size for fire brigade and authorities

Ready-made coverings in different shapes and sizes for the quick instantaneous use

Clothing and equipment for fire brigades

Fire protection covering for the floor, for example in woods, in order to prevent spreading of fires

Heat and fire protection covering for buildings in order to prevent spreading of fire

The embodiments of the invention described above serve only for better understanding the theory according to the invention defined by the claims which is not restricted itself by the embodiments.

The invention is illustrated schematically in the drawings. In the drawings:

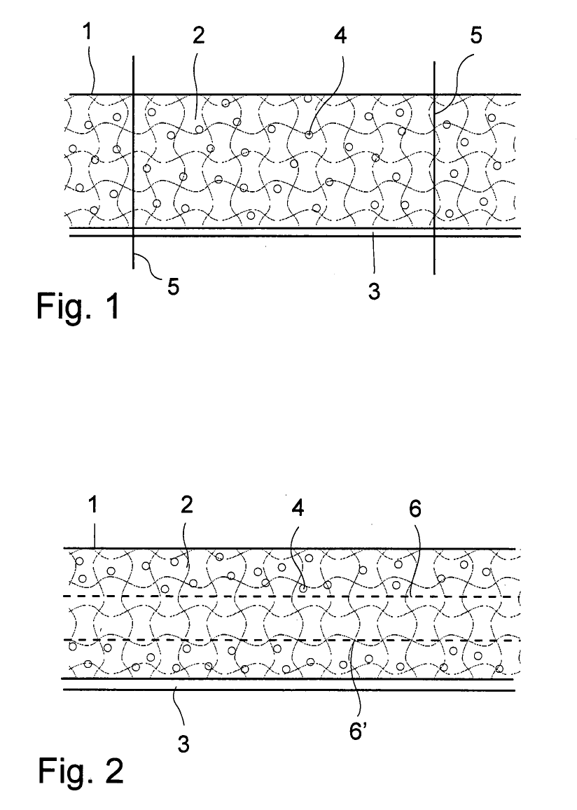

FIGS. 1, 2 each a vertical section through a covering according to the invention

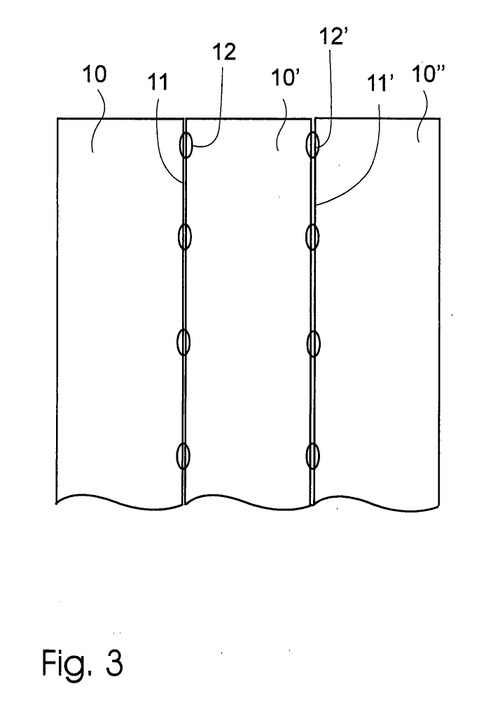

FIG. 3 in a top view a fire protection blanket according to the invention made of different coverings according to the invention.

FIGS. 1, 2 show in an enlarged drawing a section through different embodiments of the covering according to the invention. A fleece 2 with a super absorber 4 is arranged between an outside skin 1 and a cover skin 3. The outside skin 1 faces the fire and is conveniently permeable to water in order to be able to fill the super absorber 4 with liquid. The cover skin 3 facing the object to protected, on the other hand, is clearly thicker and, for example, rubber-like in order to prevent as far as possible the object to be protected from being damaged by water. According to the invention it suggested to supply the covering in lengths, as for example shown in FIG. 3. Here several lengths 10, 10′, 10″ are linked longitudinally at their edges 11, 11′ by connecting means 12, 12′ in order to obtain a surface as large as possible.

Zippers, Velcro fasteners, buttons, ropes or the like may serve for the arrangement of the connection means 12. Cleverly a connection means is chosen which effects also on the side of the outside skin 3 a link as sealing as possible in order to prevent water from intruding in the direction of the object to be protected. This may be carried out, for example, by suitable Velcro fasteners which can suitably be inserted additionally in grooves or are supplied.

Cleverly outside skin 1 and cover skin 3 are connected to each other by closing seams 5.

In FIG. 2, in contrast to the modification of FIG. 1, another distribution of the super absorber 4 in the fleece 2 is shown. In FIG. 1 the super absorber 4 is substantially distributed equally supplied in the fleece 2. In the modification of FIG. 2 the fleece has been coated here on one side or on both sides with super absorber 4 on the outside so that a middle region 7 occurs which is essentially free of super absorber. The separating layers are indicated by 6 and 6′, respectively. The result is an essentially heterogeneous construction of the super absorber in the fleece.

In the modification according to FIG. 1, for example, the thread forming a fleece is coated with the super absorber, then processed into the fleece; in the modification shown in FIG. 2 first the fleece is produced, and then is sprayed, for example, with a liquid supplied super absorber and thus wetted. The level of the separating layer 6, 6′ then follows from the viscosity of the super absorber and its concentration or weight per area.

The claims filed with the application now and to be filed later on are attempted formulations without prejudice for obtaining a broader protection.

If here on closer examination, in particular also of the prior art, it turns out that one or the other feature may be convenient for the object of the invention, however, not decisively important, of course, already now a formulation is striven for which does not contain anymore such a feature in particular in the main claim.

References in the sub-claims relate to the further design of the matter of the main claim through the characteristics of the respective sub-claim. These are, however, not to be understood as a waiver of independent protection of the matter for the characteristics of the referred sub-claims.

Characteristics only disclosed in the description so far may, in the course of proceedings, be claimed as being of inventive relevance, for example to distinguish from the state of the art.

Characteristics only disclosed in the description or even single characteristics form claims which comprise a variety of characteristics may be used at any time to distinguish from the state of the art in the first claim, and this is even if such characteristics have been mentioned in connection with other characteristics or achieve particularly convenient results in connection with other characteristics.

1-24. (canceled)

25. A heat and fire protection covering for objects, a fleece with a super absorber being arranged between an outside skin and a cover skin, characterised in that the bottom side of the covering or the cover skin is designed waterproof or impermeably to water.

26. The heat and fire protection covering according to claim 25, characterised in that the outside skin and the cover skin form a sheathing or an enveloping cover fabric for the object to be protected.

27. The heat and fire protection covering according to claim 25, characterised in that the cover skin faces the object to be protected, and the outside skin faces the fire or heat source.

28. The heat and fire protection covering according to claim 25, characterised in that the cover skin faces the object to be protected, and the outside skin faces the fire or heat source and the outside skin facing the heat or fire source is fireproof and/or air permeable and/or hardly inflammable and/or permeable to water and/or permeable to water steam.

29. The heat and fire protection covering according to claim 25, characterised in that liquid bound by the super absorber escapes by evaporating from the fleece or the covering, and the evaporation heat is taken from the environment of the covering, in particular the object covered or enveloped by the covering, and cools this object.

30. The heat and fire protection covering according to claim 25, characterised in that the covering, in particular the super absorber, absorbs and binds liquid, preferably water.

31. The heat and fire protection covering according to claim 25, characterised in that the fleece is coated with super absorber, in particular the fleece is coated on one or both sides with super absorber.

32. The heat and fire protection covering according to claim 25, characterised in that the super absorber is fixed on the fibre forming the fleece by a binding agent.

33. The heat and fire protection covering according to claim 25, characterised in that the super absorber is fixed on the fibre forming the fleece by the effect of heat and/or pressure.

34. The heat and fire protection covering according to claim 25, characterised in that the super absorber is arranged as a to a large extend homogenous layer next to one or between two fleeces and/or the super absorber is arranged in the fleece as gel, paste or flakes.

35. The heat and fire protection covering according to claim 25, characterised in that the cover skin, in particular facing the object to be protected, is well heat conducting and/or gas-tight or oxygen-tight and/or the cover skin facing the object to be protected is clearly thicker than the outside skin, and is designed, for example, rubber-like in order to prevent the object to be protected from being damaged by water.

36. The heat and fire protection covering according to claim 25, characterised in that a large-surface contact area is provided between the object to be protected and the cover skin and/or the cover skin and/or the outside skin consists of textile and/or flexible material.

37. The heat and fire protection covering according to claim 25, characterised in that the weight ratio of fleece to the super absorber is 15:1 to 1:15, preferably from 15:1 to 1:1, and in particular preferably from 7:1 to 2:1, as well as preferably 1:2 to 1:7 and/or the super absorber is arranged in a concentration of 100-500 g, preferably 200 g or 400 p per m², and/or the super absorber particles have a diameter of 10 μm to 2000 μm, and/or the super absorber particles are poly(meth)acrylic acid or poly(meth)acrylic acid copolymerides with a content of at least 50 weight % (meth)acrylic acid or interlaced sodium polyacrylates.

38. The heat and fire protection covering according to claim 25, characterised in that the fleece consists of viscose, cellulose, polyurethane, polyester, poly(tetrafluor-ethylene), silicon, aramide, polyamide or suitable mixed fabrics of the before mentioned materials, and/or the fleece has a gsm substance of 50 to 200 g per m², preferably about 70 g/m².

39. The heat and fire protection covering according to claim 25, characterised in that the outside skin and the cover skin are linked with each other by closing seams.

40. The heat and fire protection covering according to claim 25, characterised in that the covering comes in rolls or lengths, and has lateral connection means and/or the covering is designed in accordance with the shape of the objects to be covered.

41. The heat and fire protection covering according to claim 25, characterised in that the covering is designed as an article of clothing and/or the covering becomes mechanically stable and shock absorbing by the absorption of water.

42. The method for the protection of objects in the case of fire, where a heat and fire protection covering, in particular according to claim 25, is put on the object between fire or heat source, the covering is watered after that, and the evaporation of the liquid cools and thus protects the object.

43. The method for the protection of objects in the case of fire, where a heat and fire protection covering, in particular according to claim 25, is put on the object between fire or heat source, and the covering is used in the condition activated with water (moist).
